(19) United States
(12) Patent Application Publication
(10) Pub. No.: US 2008/0144001 A1
(43) Pub. Date: Jun. 19, 2008

(54) SPECTRAL IMAGING DEVICE

(76) Inventors: Bauke Heeg, Portland, OR (US); John B. Abbiss, Irvine, CA (US); Anatoliy I. Khizhnyak, Irvine, CA (US); David R. Clarke, Goleta, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/957,244

(22) Filed: Dec. 14, 2007

Related U.S. Application Data
(60) Provisional application No. 60/870,318, filed on Dec. 15, 2006.

(51) Int. Cl. G01B 11/16; G01J 3/44; G02B 27/32; G01J 3/28

(52) U.S. Cl. 356/32; 356/301; 356/256; 356/326

(57) ABSTRACT

Systems and methods for spectral imaging are disclosed. Such spectral imaging can be used to determine properties of a subject material at different locations upon the surface and/or within the material. For example, strain and/or stress within an imaged area of the material can be determined. A system for spectral imaging can include a light source, a two-dimensional sensor array configured to image light from a two-dimensional area of a subject material, a filter configured to filter light from the subject material before the light is imaged and a processor in communication with the two-dimensional sensor array. The processor can be configured to determine a property of the subject material at a plurality of locations within the two-dimensional area of the subject material. Such spectral imaging systems can facilitate the performance of piezospectroscopic measurements of two-dimensional surfaces in a rapid manner while preserving accuracy.

### PRIORITY CLAIM

This patent application claims the benefit of the priority date of U.S. provisional patent application Ser. No. 60/870,318, filed on Dec. 15, 2006 and entitled PIEZOSPECTROSCOPIC IMAGING USING A TUNABLE OPTICAL FILTER (docket no. M-16700-V1 US) pursuant to 35 USC 119. The entire contents of this provisional patent application are hereby expressly incorporated by reference.

### TECHNICAL FIELD

The present invention relates generally to optics. The present invention relates more particularly to a piezospectroscopic imaging device for measuring material properties such as stress and strain that can provide high spectral resolution.

### BACKGROUND

Piezospectroscopy (PS) includes the measurement of stress distributions within a material by measuring a shift in the peak wavelength of a particular luminescence band emitted by, for example, a collection of transition metal or rare-earth ions in the material. This is done while the material is optically excited with a laser or other optical source such as a flashlamp. The spectral shift is the result of changes in the energy of the crystal field surrounding the ions due to residual or externally introduced strain in the material.

According to contemporary methodology, the measurement of strain and/or stress involves the measurement of a spectrum that requires the use of a high resolution grating spectrometer which is used in combination with a train of optical elements comprising, for example, a microscope. In this manner, a laser can be focused to a small spot or a narrow line on the subject material, allowing high spatial resolution to be achieved while only one spectrum is measured at each focal location upon the material.

However, in order to define a two dimensional map of the strain and/or stress in the subject material according to such contemporary methodology, many such measurements need to be performed over a portion of the subject material surface. For example, if a two-dimensional (2D) map of 1000 by 1000 pixels is desired, then one million separate measurements are needed in the case of single point measurements. Depending on the signal strength, performing such a high number of one-by-one measurements could take many hours. Therefore, this type of measurement of the spectra is inefficient and is not generally suitable for quality control or process monitoring purposes. Furthermore, the equipment needed for these measurements tends to be large and expensive. Therefore, there exists a need in the art to perform piezospectroscopic measurements of a two dimensional surface in a rapid manner while preserving accuracy.

### BRIEF SUMMARY

Systems and methods are disclosed herein to provide spectral imaging. According to one or more embodiments, such spectral imaging can be used to determine properties of a subject material at different locations upon the surface and/or within the material. For example, strain and/or stress within an imaged area of the material can be determined.

According to an embodiment, a system for spectral imaging can comprise a light source, an optical filter, a two-dimensional sensor array configured to image light from a two-dimensional area of a subject material, and a processor in communication with the two-dimensional sensor array which is configured to determine a property of the subject material at a plurality of locations within the two-dimensional area of the subject material.

According to an embodiment, a method of measuring can comprise providing light from a source to a two-dimensional area of a subject material, imaging light from the two-dimensional area of a subject material using a two-dimensional sensor array, and determining a property of the subject material at a plurality of locations within the two-dimensional area of the subject material using a processor that is in communication with the two-dimensional sensor array.

This invention will be more fully understood in conjunction with the following detailed description taken together with the following drawings.

### BRIEF DESCRIPTION OF THE DRAWINGS

FIG. 1 is a block diagram of a reflective measurement apparatus, in accordance with an example of an embodiment;

FIG. 2 is a block diagram of a transmissive measurement apparatus, in accordance with an embodiment;

FIG. 3 is a chart that shows experimental transmission curves using a solid-etalon Fabry-Perot filter for four values of the angle of incidence, together with a fitted transmission curve that was drawn using Equation 2, in accordance with an example of an embodiment;

FIG. 4 is a chart that shows a directly measured spectrum of ruby that was made using a high resolution spectrometer and that also shows the reconstructed spectrum that was first made using a tunable filter and then reconstructed using Tikhonov regularization wherein differences in peak wavelength values are based on a seven point parabolic fit for both peaks, in accordance with an example of an embodiment; and

FIG. 5 shows a typical stress image obtained on an oxidized FeCrAl alloy (Kanthal A1), after 100 one hour cycles between room temperature and 1150° C., in accordance with an example of an embodiment.

Embodiments of the present invention and their advantages are best understood by referring to the detailed description that follows. It should be appreciated that like reference numerals are used to identify like elements illustrated in one or more of the figures.

### DETAILED DESCRIPTION

Systems and methods that are disclosed herein can provide spectral imaging so as to facilitate the comparatively rapid determination of material properties such as strain and/or stress. Two dimensional imaging facilitates the measurement of such properties upon an area of a subject material rather than upon a small spot or a narrow line, as is done according to contemporary methodology.

An example of an embodiment of a piezospectroscopic measurement apparatus can comprise a tunable optical filter that is configured to receive a first light beam and to provide a second light beam having a spectral profile corresponding to a tuning of the optical filter. The first light beam can be emitted by a portion of a subject material. A two-dimensional sensor array can have a plurality of pixels. Each pixel can be configured to receive at least a portion of the second light beam so as to produce a pixel signal. A plurality of pixel signals can be accumulated into an array signal for each of a plurality of different filter tunings. A plurality of array signals can be accumulated for a plurality of filter tunings corresponding to a spectrum at each pixel. The spectrum at each pixel corresponds to a measurement of at least one property of the subject material

Tuning the tunable optical filter can be accomplished, for example, by tilting the tunable optical filter within an incident beam so an incident angle of received light upon an input portion of the filter is changed. Tuning the tunable optical filter can include applying an electrical signal to the tunable optical filter to alter at least one property of the tunable optical filter. Tuning the tunable filter can include applying a change in temperature to the filter.

A laser light source can provide a laser light beam that is configured to induce a luminescent effect and/or a Raman effect in the subject material. The luminescent effect and/or Raman effect produce the first beam. The optical source can also be other than a laser, such as a flashlamp or light-emitting diode.

The tunable filter can be a Fabry-Perot filter. The tunable filter can be any other desired type of filter. The tunable filter can be omitted and non-tunable filters, such as Bayer filters, can be used as discussed below. Any desired type of filter can be used.

The measured property can be indicated by a frequency shift of the second beam compared with a spectral profile of the subject material not having the measured property. That is, the spectral profile of the subject material can be compared to the spectral profile of a reference material so as to facilitate characterization of the measured property.

A first wavelength distribution corresponding to the first light beam can be different from a second wavelength distribution corresponding to the light transmitted by the filter. The spectral shape of the second beam can include a relative width and height of at least one portion of the second spectral profile having a shape that indicates the measured property.

Each array signal is processed according to an algorithm configured to deconvolve the measured spectrum and determine an actual spectrum. The algorithm can compensate for a blurring of the second beam introduced by the tunable filter. The magnitude of the frequency shift can correspond to the magnitude of the measured property.

The plurality of array signals can correspond to a hyperspectral datacube. For example, the plurality of array signals can correspond to a hyperspectral datacube having x and y values corresponding to the pixel locations in the pixel array and having z values corresponding to the spectrum at each pixel.

A memory can be configured to store and retrieve data. The processor can be configured to receive, transmit, process, and/or store the array signal in the memory. The processor can be configured to fetch, decode, and execute instructions to provide the measurement of at least one property of the subject material.

An algorithm can be configured to deconvolve the measured spectrum and determine an actual spectrum. Such deconvolution can be useful, for example, when the measured spectrum is blurred by the tunable filter.

Tikhonov regularization can be used in data reconstruction. Tikhonov regularization can compensate for irregularities in the data and can thus better facilitate processing of the data so as to determine the desired material properties.

The memory can be removable. In this manner, data can be transferred and/or algorithms, such as deconvolution algorithms and/or Tikhonov regularization algorithms, can be modified.

According to an embodiment, a method of measuring properties of materials can comprise applying laser light to a subject material to produce a luminescent or Raman effect. The luminescent or Raman effect can produce a first light beam having a first spectral profile. The first light beam can be filtered using a tunable filter to provide a filter output beam having a second spectral profile corresponding to a tuning of the optical filter.

The filter output beam can be applied to a two-dimensional sensor array having a plurality of pixels. Each pixel can be configured to receive the first light beam and produce a pixel signal. Each pixel signal can be accumulated into an array signal for each filter tuning. A plurality of array signals can be accumulated for a plurality of filter tunings corresponding to a spectrum at each pixel. At least one property of the subject material can be determined based on the spectrum at each pixel.

The array signal can be processed to determine a frequency shift corresponding to the measurement of at least one property of the subject material. Tikhonov regularization can be used in data reconstruction.

A computer program for executing instructions for practicing an embodiment can be stored upon a computer readable medium. Such instructions can comprise instructions for operating a laser light source to provide a laser light beam, applying the laser light beam to a subject material to produce a luminescent effect wherein the luminescent effect causes the subject material to radiate a first light beam having a first spectral profile, filtering the first light beam using a tunable filter to provide a second light beam having a second spectral profile corresponding to a tuning of the optical filter, applying the filtered output beam to a two-dimensional sensor array having a plurality of pixels wherein each pixel is configured to receive the second light beam and produce a pixel signal and each pixel signal is accumulated into an array signal for each filter tuning and a plurality of array signals are accumulated for a plurality of filter tunings corresponding to a spectrum at each pixel, and determining at least one property of the subject material based on the spectrum at each pixel.

One or more embodiments can include multi-spectral imaging with a tunable filter and the subsequent regularized data can be inverted to provide a fast and accurate measurement, at each pixel of a charge coupled device (CCD) array, of the spectrum emitted by a radiating object. For example, the method can utilize ruby R1-line and R2-line luminescence using a narrow-band tilt-tunable Fabry-Perot interference filter for data acquisition. Other filter types can be employed.

The filter can have a narrow transmission. The collected data can be convolved with the filter transmission function and some form of deconvolution can be used to obtain the data of interest. Such deconvolution process can be referred to as data inversion or data reconstruction. Since the inverted data can be seriously ill-conditioned, regularization of the data can be used.

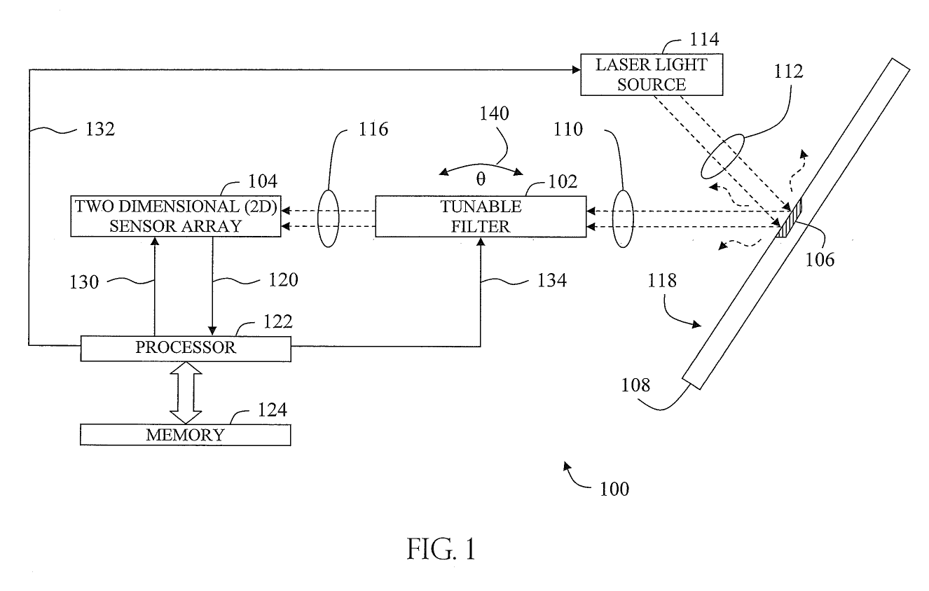

Data reconstruction can result in a peak wavelength accuracy that is sufficient to measure the small wavelength shifts encountered in ruby-like materials such as polycrystalline aluminum oxide with trivalent chromium ion impurities due to changes in the local crystal lattice stress. Peak wavelength accuracy or resolution can be about 0.01 nm using present filter technology. Thus, one or more embodiments can provide piezo-spectroscopic imaging with one to three orders of magnitude faster mapping of local stress than contemporary techniques. One or more embodiments can include the use of a narrow tunable bandpass filter for hyperspectral imaging in conjunction with image reconstruction using regularized data inversion. An exemplary measurement process is described below with reference to FIG. 1.

FIG. 1 is a block diagram of a reflective measurement apparatus 100, in accordance with an embodiment. A tunable filter 102 can be located in front of a two-dimensional sensor array 104, such as a charge-coupled device (CCD) array. Radiation from a portion 106 of a subject material 108 can be emitted as a beam 110 due to stimulation of portion 106 by laser light 112 provided by a laser light source 114. In this manner, the beam 110 has a first spectral profile and can be applied to the filter 102 and then emerge as a second beam 116 having a second spectral profile, where the second beam 116 is imaged onto the sensor array 104. The laser light 112 is applied to a first surface 118 of the subject material 108 and radiation is emitted from the first surface 118 and captured by the sensor array 104. Radiation can be due to the luminescence spectra emitted by an excited material.

Pixels of the sensor array 104 produce a signal that is aggregated into a sensor array output signal 120 and applied to a processor 122. The output signal 120 can be a serial, parallel, or serial-parallel signal in that some or all of the pixel outputs can be applied at the same time. In this manner, some or all of the pixel signal outputs can be stored in a memory portion of the sensor array 104 and then serially read out or transferred in parallel to the processor 122 that can use a removable or non-removable memory 124 to store data and/or instructions.

In this manner, captured or processed data can be downloaded from the processor 122 and/or algorithm instructions can be uploaded to the processor 122 in order to perform the data extraction, deconvolution, or other processing. Memory 124 can be a computer readable medium on which is stored a computer program for executing the algorithm. Processor 122 can provide control signals 130 to sensor array 104 in order to control capture and/or data transfer. Similarly, processor 122 can provide control signals 132 to the laser light source 114 in order to control the output of beam 112. Processor 122 can provide control signals 134 to the tunable filter 102 in embodiments where the filter 102 is electronically tunable.

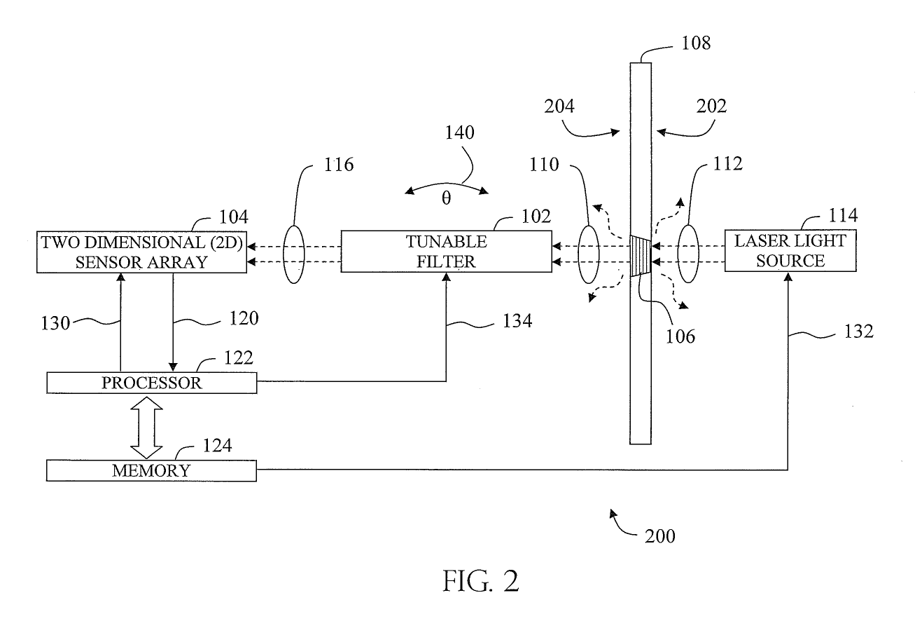

FIG. 2 is a block diagram of a transmissive measurement apparatus 200, in accordance with an embodiment. The apparatus of FIG. 2 is similar to FIG. 1, except that in FIG. 2 the laser light 112 is applied to a first surface 202 of the subject material 108 and radiation is emitted from a second surface 204 of the subject material 108. That is, in FIG. 2 the laser light 112 is transmitted through the subject material 108 instead of being reflected therefrom so as to be communicated to the tunable filter 102.

Referring now to FIGS. 1 and 2, each pixel in the array 104 can image a different part of the radiating subject material, based on the resolution that can be varied, to capture an array image based on the tuning of the tunable filter 102. Then, once the image is captured, the filter tuning can be changed (in one case, the filter can be tilted) and another image can be captured. In this manner, a sequence or series of images can be collected. For example, about 100 images can be captured. Each image can correspond to a different transmission wavelength of the tunable filter. Using the series of images, a spectrum can be obtained at each pixel. The collection of measurement data can be considered a three-dimensional hyper-spectral data-cube, where x and y corresponds to the location of pixels in a pixel array, and z corresponds to a collection of image data, comprising the image spectrum, at each pixel.

In a particular application, the stress inside aluminum oxide based materials can be indicated and measured by means of a shift in the R1 and R2 peaks that can arise from excited Cr3+ ions in an alumina-based compound such as ruby or polycrystalline alumina. However, embodiments can utilize other ions or host materials such as spinel or aluminum oxynitride, and can be suitable for a much broader range of applications. For example, several rare earth ions that experience stress can show a similar shift in their respective spectra.

Alternatively, the measurement of stress does not necessarily rely on the response of excited ions at all, since Raman spectroscopy can also be used. The Raman piezospectroscopic effect, where a shift in the Raman peak is related to stress in the subject material, can also be manifested. Examples can include Raman measurement of stress in industrial materials, such as silicon, silicon carbide, zirconia ceramics, and others. In particular, stress imaging in semiconductor materials by means of the Raman shift is desirable when electronics designs are miniaturized, since stress in the semiconductor components can become an important factor. Alternatively, the measurement does not involve measuring the shift in the spectrum, but a more general change in the spectrum, such as a change in the spectral distribution. Alternatively, the method is used to measure whether the change in the spectrum has exceeded a particular value. Alternatively, the method is used to measure the spatially dependent spectra in general, in applications other than piezospectroscopy.

However, since the filter can have a finite bandpass range, the spectrum at each pixel can be distorted. In this manner, rather than providing the desired true spectrum, a convolved spectrum is provided that is somewhat blurred and broadened To address this problem (i.e., when the measured or image spectrum at each pixel is convolved with the filter transmission function corresponding to the properties of the tunable filter), the true spectrum can need to be extracted or reconstructed from the convolved measured spectrum.

However, this type of deconvolution problem is typically considered to be ill-posed, where the true spectrum cannot be extracted without simultaneously introducing very large error contributions from noise. To address this further issue, regularized data inversion can be used. In this manner, using a small stabilization parameter, the sensitivity to noise (i.e., measurement fluctuations) can be significantly reduced, and the true spectrum can be reconstructed from the image spectrum. Other methods are available to solve convolution problems of this kind, and embodiments do not rely on the specific use of regularized data inversion. For example, inversion can be achieved with the wavelet approach, or with Bayesian deconvolution.

By using the above described apparatus and method, a significant improvement over prior art stress imaging techniques is provided where the data acquisition time is drastically reduced. Instead of one million measurements for a one-megapixel image, the current method can use only about 100 measurements with similar data acquisition time per measurement. Once the image is captured, the image can be processed according to an efficient algorithm. In this manner, a complete solution including capture and data processing can be accomplished in several minutes, instead of several hours.

Embodiments can also significantly reduce the instrument size, compared with previous instruments, where the instrument can be not only smaller but also more affordable than prior spectrometer systems. Furthermore, embodiments can have no or very few polarizing optics, thus having a reduced sensitivity to polarized emission from the material. The CCD array can be a conventional camera, or it can be a time-gated camera, such as a directly modulated camera or an image-intensified camera. When using a time-gated camera, enhanced sensitivity to a useful signal can be obtained by reducing sensitivity to unwanted background radiation. Furthermore, the optical throughput of the imaging system can be higher than a conventional grating spectrometer Further, the optical excitation can not rely on a large train of optical components, such as in the case of a microscope.

The overall optical excitation power that can be used can need to be higher than in conventional methods, since the entire surface area needs to be illuminated to provide for simultaneous measurement, while the lower attenuation of the optical systems can partially compensate for an increase in optical (laser) power. Embodiments can benefit from the continuous improvement in CCD technology and in computer technology, particularly in algorithm execution speed. Thus larger stress images can be obtained and processed in the future, in a shorter amount of time.

Apart from the local stress, as measured by the piezospectroscopic shift of the R-lines, several other types of information can be obtained from the luminescence spectrum. For example, additional inhomogeneous broadening of the R-lines (i.e., in excess of thermal broadening) can occur in the case of a stress gradient existing across the probe volume, or in the case of a probe volume containing multiple grains of a polycrystalline material. Alternatively, the R1/R2 peak separation can be used to determine the non-hydrostaticity of the stress. These and other examples show that, for a detailed analysis, preferably the entire R1/R2 spectrum is measured, i.e., not only the region around the peaks.

As shown in FIGS. 1 and 2, the tunable filter 102 can be implemented as a Fabry-Perot dielectric filter having a narrow passband that can be shifted in wavelength by changing the angle of incidence θ 140 of the incoming light beam 110 to capture a full spectrum of the incoming radiation. At a given value for θ—defined as the angle of incidence 140 of collimated light with respect to the surface normal of the tunable filter—the total energy received by one pixel of the detector, g(θ) can be recorded. Thus, by varying the angle of incidence, one obtains for each pixel at the detector the following measured spectrum or ‘image spectrum’:

g(θ)=∫_{-∞}^{∞}T(θ,λ)f(λ)dλ (Equation-1)

where T(θ,λ) is the transmittance of the filter as a function of wavelength, λ and incidence angle, and f(λ) is the spectrum of the source. In the present case, T(θ,λ) is a function describing a tilt-tunable (all dielectric) narrow band Fabry-Perot filter:

$$T = {{T}_{0} [ 1 + F {sin}^{2} ( \frac{2 π}{λ} L {n}_{s} cos {θ}_{i} ) ]}^{- 1} , \qquad ( Equation \text{-} 2 )$$

where nₛ and L are the refractive index and thickness of the solid spacer (cavity), θᵢ is the angle of incidence inside the spacer, T₀ is the peak transmittance, and F=4R/(1−R)², the coefficient of finesse, with R being the reflectivity of the multilayer stack. The internal spacer angle can be related to the external angle of incidence θ by means of the relation cos θᵢ=(1−sin² θ₀/n_{eff}²)^{1/2}, where n_{eff} is the effective refractive index of the Fabry-Perot filter. Thus, given g(θ), the determination of f(λ) becomes an inverse problem described by Eq. (1), a Fredholm integral equation of the first kind. In practice, g(θ) is discretized, and the integral equation becomes a matrix-algebra equation taking the form

g=Tf, (Equation-3)

where g is a vector of length m, say, and T is a matrix whose rows represent the transmittance of the filter for a given external angle of incidence, θ. For an n-point reconstruction of the source spectrum f, T is then an m×n matrix. The standard least-squares solution is

f=(T′T)⁻¹T′g (Equation-4)

where T′ is the transpose of T. The inversion of T′T can, however, present serious difficulties if, as here, T is badly ill-conditioned. The degree of ill-conditioning can be characterized by the condition number of the matrix, defined as the ratio of its largest singular value to its smallest. In such a case, even extremely small amounts of noise can render the reconstruction, computed via the inverse of T′T, meaningless. It can easily be shown that the near-Lorentzian T is indeed badly ill-conditioned. To deal with the problem, constraints must be applied, for which the methods of regularization theory are particularly attractive. Here, we make use of the Tikhonov regularization method. Essentially, a small stabilizing parameter α is included in the inversion procedure, and the least-squares solution modified to read:

f=(T′T+αI)⁻¹T′g, (Equation-5)

where I is the unit matix. (T′T+αI)⁻¹T′ will be referred to as the regularized pseudo-inverse (RPI) matrix. A vital feature of the reconstruction scheme is the regularization parameter α, whose value depends closely on the signal-to-noise ratio of the input data. A closed form for computing the optimum α is, in general, not known, although in some special circumstances it can be related directly to the signal-to-noise ratio. In general, the optimum α will represent a trade-off between resolution and smoothness in the results, and can be found by experimenting over a range of values. A widely used tool for finding the optimum is the so-called L-curve, where the (Euclidean) norm of the reconstruction is plotted against the norm of the residuals (the difference between the original image and the re-imaged reconstruction). Here, the optimum value for α was chosen on the basis of minimal difference between real and reconstructed peak wavelengths. The transmittance of a commercial tunable filter (0.25 nanometer FWHM), obtained from Omega Filters, was measured as a function of input angle and wavelength, using a collimated white light source and a spectrometer with a resolution of approximately 0.07 nm (Ocean Optics). A sum of four terms based on Eq. (2) was fitted to a sum of four experimental transmission curves, using 5 fitting variables (including baseline and normalization). The external incidence angles, θ₀, were introduced as constants.

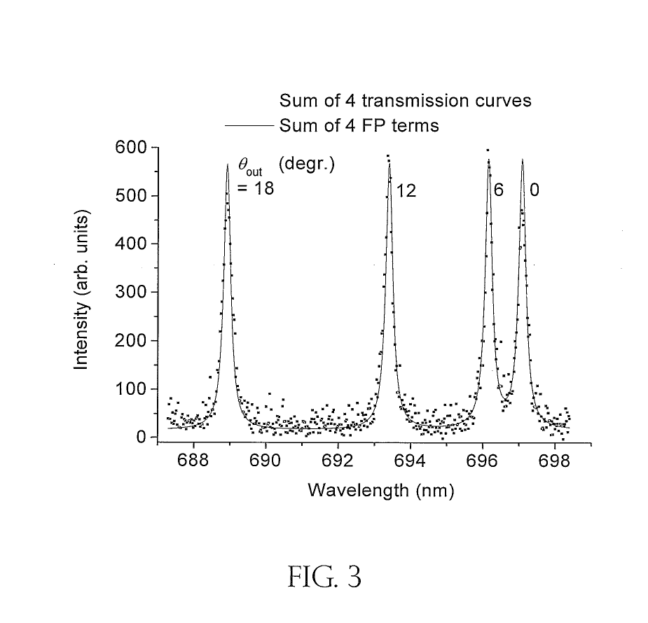

FIG. 3 shows experimental transmission curves with a solid-etalon Fabry-Perot filter, as an embodiment of the tunable filter 102, for four values of the angle of incidence, together with a fitted transmission curve, using Equation-2. The best fit, as shown in FIG. 3, was used to construct a T-matrix. The large tuning range was chosen to facilitate scanning across the R1/R2 spectrum. Next, the flat end-face of a ruby laser crystal was illuminated with several milliwatts of 532 nm (Nd:YAG) laser radiation, in the form of a thin sheet exciting luminescence only at the crystal surface and a thin layer of approximately ½ mm underneath. The luminescence intensity transmitted through the Fabry-Perot filter was measured with a silicon detector, over a range of values for θ₀ between zero (normal incidence) and 18 degrees.

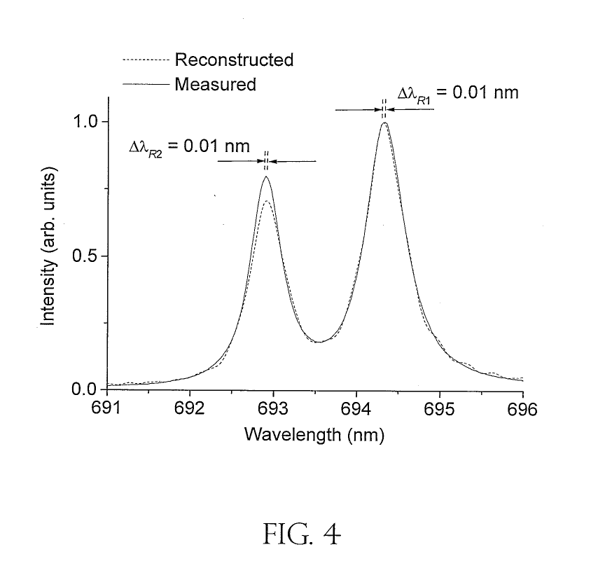

FIG. 4 shows a directly measured spectrum (using high resolution spectrometer) of ruby, and the reconstructed spectrum, using Tikhonov regularization. Differences in peak wavelength values based on a 7-point parabolic fit are given for both peaks. The value of α=0.01 was found to be about optimum for this set of data. The spectrometer was checked for correct wavelength calibration with a low pressure Hg—Ne lamp, yielding wavelength accuracy to within approximately 0.01 nm. From the spectrometer data fits, the peak wavelength values obtained were 694.33 nm (R1) and 692.90 nm (R2) (i.e., 14402.5 cm-1 and 14432.1 cm-1, respectively). The peak wavelengths for the reconstructed spectrum are 694.32 nm (R1) and 692.91 nm (R2). The experimental accuracy of the reconstruction, based on the 7-point peak fit, is therefore 0.01 nm for both peaks. This accuracy of ˜0.2 cm-1 corresponds to a stress resolution of ˜40 MPa, based on a piezo-spectroscopic shift of 5.08 cm-1/GPa and biaxial stress conditions, which is sufficiently small to follow changes in the stress associated with aging of typical superalloy structures.

In the imaging mode, two lenses, located at their focal distances from the CCD and the object, respectively, were used to form an image on the CCD. The filter was located in the collimated region between the two lenses. Thus, the radiation from a given object area—say, location (x,y) within the field of view that corresponds to the pixel (m,n) of the CCD—is incident on the tunable filter as a parallel beam. In that case, the transmission function is well-defined in terms of Eq. (2). However, while this optical configuration ensures that the light incident on the filter is collimated, the beam direction itself varies with the location in object space, (x,y), and hence with pixel number (m,n). Therefore, the effective angle of incidence for each pixel at a given filter setting was calculated from geometrical principles as a function of rotation stage angle, and used to calculate the RPI matrix for each pixel.

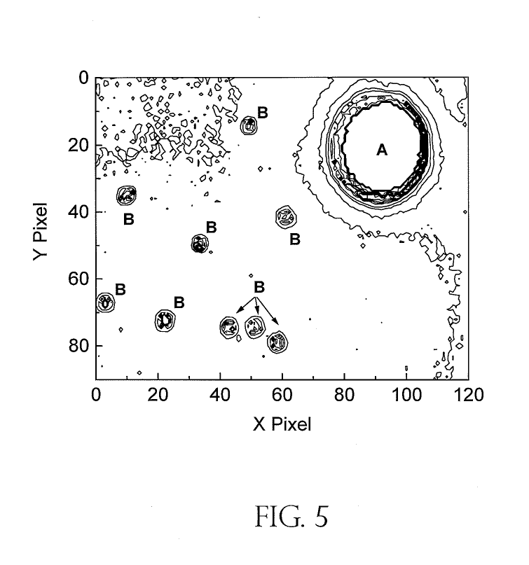

FIG. 5 shows a typical stress image obtained on a subject material of oxidized FeCrAl alloy (Kanthal A1), after 100 one hour cycles between room temperature and 1150° C. The stress image was obtained by collecting 201 images at different filter settings, with each image approximately half a second exposure. The peak wavelengths of the reconstructed spectra at each pixel were subtracted from a stress free reference wavelength, and converted to stress by applying a conversion of 5.08 cm-1/GPa, which is the stress coefficient under biaxial stress conditions.

Region A is a hole in the subject material used for mounting it in a furnace. Regions B are areas on the surface where the oxidized coating has spalled. The contours represent regions of equal stress as measured by the residual strain. The stress around this hole can be seen to decrease gradually with position or distance from the hole as a result of stress relaxation. Away from the spalled regions and the hole, the coating is under a uniform stress in this subject material. Approaching the hole and spalled regions, the stress decreases as a result of strain relief. Since no luminescence is collected from the hole area, the stress is set to zero within the hole. At several locations in the image, small areas are found where spallation of the alumina scale has occurred. These areas similarly show a gradual decrease in stress around the spalled areas as a result of stress relief. A line profile can be used to show how stress varies with position.

The wavelength resolution across the pixel array is typically on the order of ±0.01 nm, which corresponds to a biaxial stress resolution of ±40 MPa. This resolution was obtained from a calibration of the system with atomic emission lines such as Ne, Ar and Hg. FIG. 5 is an image with approximately 50 micron resolution, and a size of 120 by 90 pixels. However, a diffraction limited resolution of approximately one micron should be attainable. The analyzed image size is dictated primarily by the computational power and memory of the computer.

Similar images have been obtained for oxidized alloys covered with zirconia-type thermal barrier coatings (TBCs). The laser and luminescence radiation experience a small attenuation in electron-beam vapor deposited (EB-PVD) zirconia coatings, however this attenuation does not otherwise affect the stress measurement.

One or more embodiments can use a two dimensional sensor array that has built in filters, such as Bayer filters. In such embodiments, the tunable filter 102 can be omitted. Such embodiments can be used for lower resolution spectral imaging. For example, such embodiments can be used for identifying regions of comparatively high and low strain and/or stress.

Discussed above is a method to accurately reconstruct the ruby R1/R2 spectra for a 2-dimensional array of CCD pixels by means of a tunable filter with a resolution beyond the limit imposed by the filter transmission bandwidth. The experimental accuracy of the reconstruction method was found to be ˜0.01 nm for both peaks, which was close to simulation predictions. This accuracy is sufficient to resolve the small shift in Cr3+ luminescence spectra associated with changes in the local stress inside aluminum oxide.

An example of an application of embodiments can include use in quality control. For example, material properties such as strain and/or stress of products in an assembly line can be determined. The determination of such material properties can be automated. Products that have undesirable properties, such as excessive strain and/or stress, can be discarded. Embodiments using a Bayer filter rather than a tunable filter can be particularly well suited for such screening applications.

Another example of an application of embodiments can include use in infrared spectroscopic (hyperspectral) imaging. This application does not necessarily require that the signal is generated with a laser or other source. Thus, passive imaging can be provided. The types of optical signals that can be analyzed include: (1) photo-stimulated luminescence (also referred to as photo-luminescence, which includes fluorescence and phosphorescence) which can be generated with a laser or other optical source such as a flashlamp or light emitting diode (LED); (2) photo-stimulated scatter (which includes Raman signals); and (3) passive optical signals such as infrared imaging.

When passive imaging (imaging without the use of illuminating light) is performed, then emission from the subject material can be encouraged or stimulated by other means. For example, the emission of light from the subject material can be stimulated by heating the subject material. The subject material can be heated using infrared radiation or by any other desired means.

Thus, imaging can be either active (using a light source such as a laser) or passive (lacking such a light source). Further, imaging can be performed on an emitting source or on an attenuating source. In the first case, which includes both active and passive imaging, the light emitted by the source is more intense than the background light. In the second case, which typically includes only passive imaging, the optical signal is characterized by being of lower intensity than the background signal.

Some embodiments of the spectral imaging system facilitate the performance of piezospectroscopic measurements of two dimensional surfaces in a rapid manner while preserving accuracy. Some embodiments of the spectral imaging system facilitate the performance of piezospectroscopic measurements of two dimensional surfaces in a rapid, although less accurate manner while utilizing simplified instrumentation (such as by using Bayer filters instead of a tunable filter).

Embodiments described above illustrate but do not limit the invention. It should also be understood that numerous modifications and variations are possible in accordance with the principles of the present invention. Accordingly, the scope of the invention is defined only by the following claims.

1. A spectral imager comprising:
a filter configured to receive light from a two-dimensional area of a subject material;
a two-dimensional sensor array configured to image light from the two-dimensional area of the subject material that has passed through the filter; and
a processor in communication with the two-dimensional sensor array and configured to determine a property of the subject material at a plurality of locations within the two-dimensional area of the subject material.

2. The spectral imager as recited in claim 1, further comprising a light source configured to provide light to the two-dimensional area of a subject material.

3. The spectral imager as recited in claim 2, wherein the light source comprises a laser.

4. The spectral imager as recited in claim 2, wherein the light source comprises a laser that is configured to cause at least one of a luminescent effect and a Raman effect in the subject material.

5. The spectral imager as recited in claim 1, wherein the two-dimensional sensor array comprises a charge coupled device (CCD).

6. The spectral imager as recited in claim 2, wherein the light source and the two-dimensional surface are configured to facilitate imaging light that has been reflected from the subject material.

7. The spectral imager as recited in claim 2, wherein the light source and the two-dimensional source are configured to facilitate imaging light that has been transmitted through the subject material.

8. The spectral imager as recited in claim 1, wherein the filter changes a spectral content of light from the subject material that is imaged by the two-dimensional sensor array.

9. The spectral imager as recited in claim 1, wherein the filter comprises a tunable filter for changing a spectral content of light from the subject material that is imaged by the two-dimensional sensor array.

10. The spectral imager as recited in claim 1, wherein the filter comprises a tunable filter for changing a spectral content of light from the subject material that is imaged by the two-dimensional sensor array and wherein tuning the tunable filter comprises tilting the tunable filter within light from the subject material so that an incident angle of received light upon an input portion of the filter is changed.

11. The spectral imager as recited in claim 1, wherein the filter comprises a tunable filter for changing a spectral content of light from the subject material that is imaged by the two-dimensional sensor array and wherein tuning the tunable filter comprises applying an electrical signal to the tunable filter to alter at least one property of the tunable optical filter.

12. The spectral imager as recited in claim 1, wherein the filter comprises a tunable Fabry-Perot filter for changing a spectral content of light from the subject material that is imaged by the two-dimensional sensor array.

13. The spectral imager as recited in claim 1, wherein the two-dimensional sensor array comprises a Bayer filter.

14. The spectral imager as recited in claim 1, wherein the processor is configured to determine at least one of a strain and a stress of the subject material at a plurality of locations within the two-dimensional area of the subject material.

15. The spectral imager as recited in claim 1, wherein the processor is configured to determine strain and/or stress of the subject material at a plurality of locations within the two-dimensional area of the subject material and to facilitate the definition of an image of the strain and/or stress at a plurality of locations within the two-dimensional area of the subject material.

16. The spectral imager as recited in claim 1, wherein the processor is configured to accumulate a plurality of signals from the two-dimensional sensor array, the signals being accumulated for a plurality of different filter tunings and the signals corresponding to a spectrum at each pixel, the spectrum at each pixel corresponding to a measurement of at least one property of the subject material.

17. The spectral imager as recited in claim 1, wherein the processor is configured to determine a property of the subject material that is indicated by a frequency shift of the light as compared with a spectral profile of the subject material not having the same property.

18. The spectral imager as recited in claim 1, wherein the processor is configured to process signals from the two-dimensional sensor array so as to deconvolve a measured spectrum so as to facilitate a determination of an actual spectrum.

19. The spectral imager as recited in claim 1, wherein the processor is configured to compensate for a blurring of the light that is caused by a tunable filter.

20. The spectral imager as recited in claim 1, wherein the processor is configured to determine a magnitude of a frequency shift that corresponds to a magnitude of a measured property.

21. The spectral imager as recited in claim 1, wherein the processor is configured to process an array signals that correspond to a hyperspectral datacube having x and y values corresponding to the pixel locations in the pixel array and having z values corresponding to the spectrum at each pixel.

22. The spectral imager as recited in claim 1, wherein the processor is configured to use Tikhonov regularization in data reconstruction.

23. A method of measuring, the method comprising:
filtering light from a two-dimensional area of a subject material;
imaging filtered light from the two-dimensional area of a subject material using a two-dimensional sensor array; and
determining a property of the subject material at a plurality of locations within the two-dimensional area of the subject material using a processor that is in communication with the two-dimensional sensor array.

24. A passive spectral imager comprising:
a two-dimensional sensor array configured to image light from a two-dimensional area of a subject material; and
a processor in communication with the two-dimensional sensor array and configured to determine a property of the subject material at a plurality of locations within the two-dimensional area of the subject material.

25. A method of passive measuring, the method comprising:
imaging light from a two-dimensional area of a subject material using a two-dimensional sensor array; and
determining a property of the subject material at a plurality of locations within the two-dimensional area of the subject material using a processor that is in communication with the two-dimensional sensor array.
